(19) United States
(12) Patent Application Publication
(10) Pub. No.: US 2014/0191477 A1
(43) Pub. Date: Jul. 10, 2014

(54) HYDROGENATED NITRILE RUBBER COMPOSITION

(71) Applicants: Osamu Kobayashi, Tokyo (JP); Hideyuki Murakami, Tokyo (JP)

(72) Inventors: Osamu Kobayashi, Tokyo (JP); Hideyuki Murakami, Tokyo (JP)

(21) Appl. No.: 14/239,035

(22) PCT Filed: Aug. 3, 2012
(86) PCT No.: PCT/JP2012/069852

§ 371 Date: Feb. 14, 2014

(30) Foreign Application Priority Data
Sep. 13, 2011 (JP) 2011-199558

(51) Int. Cl. C08K 3/04; F16J 15/02; C08K 3/26; C08K 3/36; C08K 3/34; C08K 3/22

(52) U.S. Cl. CPC C08K 3/04; C08K 3/346; C08K 3/34; C08K 3/22; C08K 3/26; C08K 3/36; F16J 15/02
USPC 277/650; 524/566; 524/445; 524/451; 524/430; 524/425; 524/443

(57) ABSTRACT

Disclosed is a hydrogenated nitrile rubber composition comprising 100 parts by weight of hydrogenated nitrile rubber having a bound acrylonitrile content of 31 to 50% and an iodine value of 30 mg/100 mg or less, 30 to 300 parts by weight of carbon black having a particle size of 61 nm or more and/or other filler, 0.5 to 30 parts by weight of a polyfunctional unsaturated compound cocrosslinking agent, and 1 to 10 parts by weight of an organic peroxide. The hydrogenated nitrile rubber composition has excellent roll processability and can be suitably used as a vulcanization-molding material for a cup gasket or bellows having excellent LLC resistance used in a water pump mechanical seal.

### TECHNICAL FIELD

The present invention relates to a hydrogenated nitrile rubber composition. More particularly, the present invention relates to a hydrogenated nitrile rubber composition that can be suitably used as a vulcanization-molding material for cup gaskets or bellows of mechanical seals used in water pumps of radiators, etc., for automobiles and construction machinery.

### BACKGROUND ART

Water pumps are pumps in which an aqueous solution comprising ethylene-glycol, etc., as active ingredients is used as LLC (long life coolant), which is an anti-freeze fluid. Water pump mechanical seals used to seal LLC are disclosed, for example, in Patent Document 1. Cup gaskets and bellows, which are used as members of the mechanical seals and which are static seals incapable of sliding, are made from rubber materials. Patent Document 1 refers to FKM (fluororubber), NBR, IIR, U (polyurethane rubber, such as AU and EU), Q (silicone rubber, such as VMQ and FVMQ), CR, and the like as usable examples of rubber materials for the cup gaskets.

These members are used to seal (secondary sealing) between sealing materials and members for fixing the sealing materials. For example, rubber materials itself used for lip seals are required to be hard because the rubber itself is a sliding body. Unlike such materials, rubber materials itself for the cup gaskets and bellows are required to be elastic enough to prevent the formation of gaps between the sealing members and the fixing members. More specifically, the rubber materials for these members are required elasticity having a hardness (Durometer A; according to JIS K6253 corresponding to ASTM D2240, Durometer Type A) of less than 70.

Since rubber materials generally used in mechanical seal members must have certain levels of hardness and elastic modulus so as to seal gaps between the members, the rubber materials are compounded with only small amounts of fillers, which have high reinforcing properties. Consequently, the volume fraction of the rubber polymer increases, and the desired resistance to LLC (long life coolant) is less likely to be ensured.

More specifically, the cup gaskets and bellows are required to have the following properties:

(1) Since mechanical seals are used under conditions in which they are always in contact with sealing liquid, such as LLC, in an atmosphere circumstances of high temperature (up to 160° C.) and high pressure (up to 0.4 MPa), the cup gaskets or bellows, which are used as members of the mechanical seals, are required to have durability under such conditions. An improvement in LLC resistance is needed to enable the cup gaskets or bellows to sufficiently exhibit their performance.

(2) Flexible elastomeric materials, such as nitrile rubber, are used as vulcanization-molding materials for the cup gaskets and bellows, which are members of water pump mechanical seals. In order to ensure certain levels of hardness and elastic modulus, it is necessary to lessen the amounts of various fillers. Consequently, the volume fraction of the rubber polymer increases, and the desired LLC resistance cannot be ensured.

(3) If the LLC resistance of the cup gaskets and bellows is insufficient, swelling and softening cause destruction (rupture), thereby resulting in the leakage of a large amount of LLC. In the worst-case scenario, a breakdown caused by overheating occurs.

(4) In order to solve these problems, for example, Patent Documents 2 and 3 disclose (hydrogenated) nitrile rubber compositions comprising nitrile rubber or hydrogenated nitrile rubber, and magnesium hydroxide, without containing a zinc compound or calcined clay. In Examples of these documents, FEF carbon black is used as a filler; however, the use of FEF carbon black (particle size: 45 nm) results in inferior roll processability, as shown in the results of Comparative Example 1 to 3, described later.

### PRIOR ART DOCUMENT

### Patent Document

Patent Document 1: JP-A-2005-265075

Patent Document 2: JP-A-2001-354806

Patent Document 3: JP-B-3676338

Patent Document 4: JP-A-2006-131700

Patent Document 5: JP-A-2002-80639

### OUTLINE OF THE INVENTION

### Problem to be Solved by the Invention

An object of the present invention is to provide a hydrogenated nitrile rubber composition that has excellent roll processability and can be suitably used as a vulcanization-molding material for a cup gasket or bellows having excellent LLC resistance used in a water pump mechanical seal.

### Means for Solving the Problem

The above object of the present invention can be achieved by a hydrogenated nitrile rubber composition comprising 100 parts by weight of hydrogenated nitrile rubber having a bound acrylonitrile content of 31 to 50% and an iodine value of 30 mg/100 mg or less, 30 to 300 parts by weight of carbon black having a particle size of 61 nm or more and/or other filler, 1 to 30 parts by weight of a polyfunctional unsaturated compound cocrosslinking agent, and 1 to 10 parts by weight of an organic peroxide. This hydrogenated nitrile rubber composition is preferably free of a plasticizer.

### Effect of the Invention

The hydrogenated nitrile rubber composition of the present invention has excellent roll processability, and can be crosslinked with peroxide to form a cup gasket or bellows having excellent LLC resistance used for a water pump mechanical seal.

### Embodiments for Carrying Out the Invention

The hydrogenated nitrile rubber used in the present invention has a bound acrylonitrile [AN] content of 31 to 50%, preferably 35 to 50%, and an iodine value of 30 mg/100 mg or less. The use of hydrogenated nitrile rubber in which the bound AN content and iodine value are outside the above range results in inferior LLC resistance.

The hydrogenated nitrile rubber composition having such properties is compounded in an amount of 100 parts by weight with carbon black having a particle size of 61 nm or more and/or other filler in an amount of 30 to 300 parts by weight, preferably 40 to 160 parts by weight. When the proportion of carbon black and/or other filler is less than this range, LLC resistance is insufficient; whereas when the proportion is greater than this range, roll processability is inferior.

Examples of the carbon black include those having a particle size (according to ASTM D1765) of 61 nm or more, preferably 61 to 500 nm. The use of carbon black having a particle size less than this range results in inferior roll processability. Moreover, examples of the filler other than the carbon black include silica, graphite, clay, talc, coke, calcium carbonate, alumina, silicon carbide, titanium oxide, and the like; preferably, at least one of graphite, silica, clay, etc., is used. The particle size of the other filler is not particularly limited, but is generally about 0.5 to 250 μm.

Since the use of a specific amount of such a filler can produce a rubber material having certain levels of hardness and elastic modulus and can reduce the volume fraction of the rubber polymer, the resulting rubber material has excellent LLC resistance. In general, a plasticizer is compounded to control hardness; however, the plasticizer is extracted at the time of use, consequently leading to changes in physical properties, such as hardness increase. It is thus preferable that a plasticizer is not used in the hydrogenated nitrile rubber composition of the present invention.

When any of these various other fillers, particularly silica, is used, it is preferable to use it in combination with a coupling agent, such as a silane-, titanium-, zirconium-, or aluminum-based coupling agent, in an amount of 8 parts by weight or less, preferably 5 parts by weight or less, based on 100 parts by weight of the hydrogenated nitrile rubber.

Examples of silane-based coupling agents include vinyl group-, epoxy group-, and amino group-containing silane coupling agents, such as vinyltrichlorosilane, vinyltrimetoxysilane, vinyltriethoxysilane, 2-(3,4-epoxycyclohexyl)ethyltrimethoxysilane, 3-glycidoxypropyltrimetoxysilane, 3-glycidoxypropylmethyldiethoxysilane, N-2-(aminoethyl)-3-aminopropylmethyldimethoxysilane, 3-aminopropyltrimethoxysilane, and N-phenyl-3-aminopropyltrimethoxysilane.

Examples of titanium-based coupling agents include titanium diisopropoxy bis(triethanolaminato), titanium lactate ammonium salt, titanium lactate, titanium dioctyloxy bis(octyleneglycolate), and the like.

Examples of zirconium-based coupling agents include zirconium tetra-n-butoxide, zirconium tetraacetylacetonate, zirconium tributoxy monoacetylacetonate, zirconium monobutoxy acetylacetonate bis(ethylacetoacetate), zirconium butoxy bis(ethylacetoacetate), zirconium tetraacetylacetonate, zirconium tributoxy monostearate, and the like.

Moreover, examples of aluminum-based coupling agents include acetoalkoxy aluminum diisopropylate, and the like.

Examples of the organic peroxide include di-t-butyl peroxide, dicumyl peroxide, t-butylcumyl peroxide, 1,1-di(t-butylperoxy)-3,3,5-trimethylcyclohexane, 2,5-dimethyl-2,5-di(t-butylperoxy)hexane, 2,5-dimethyl-2,5-di(t-butylperoxy)hexyne-3,1,3-di(t-butylperoxyisopropyl)benzene, 2,5-dimethyl-2,5-di(benzoylperoxy)hexane, t-butylperoxy benzoate, t-butylperoxy isopropyl carbonate, n-butyl-4,4′-di(t-butylperoxy) valerate, and the like. The proportion of organic peroxide is about 1 to 10 parts by weight, preferably about 2 to 8 parts by weight, based on 100 parts by weight of the hydrogenated nitrile rubber. When the amount of organic peroxide is less than this range, the resulting vulcanizate has an insufficient crosslinking density. In contrast, when the amount is greater than this range, foaming occurs, and vulcanization-molding cannot be performed; or, if vulcanization-molding can be performed, rubber elasticity and elongation decrease.

Furthermore, preferred examples of the polyfunctional unsaturated compound cocrosslinking agent include difunctional or trifunctional (meth)acrylates, such as ethyleneglycol dimethacrylate, triethyleneglycol dimethacrylate, 1,4-butyleneglycol dimethacrylate, 1,6-hexanediol dimethacrylate, and trimethylolpropane trimethacrylate. Other usable examples are triallyl isocyanurate, triallyl cyanurate, triallyl trimellitate, diallyl isocyanurate, and other allyl-based cocrosslinking agents that are generally used in combination with organic peroxides. The term “(meth)acrylate” as used herein refers to acrylate or methacrylate.

The proportion of polyfunctional unsaturated compound cocrosslinking agent is 0.5 to 30 parts by weight, preferably 1 to 10 parts by weight, based on 100 parts by weight of the hydrogenated nitrile rubber. When the proportion is less than this range, the desired LLC resistance (degree of swelling and degree of softening) targeted by the present invention cannot be achieved. As a result, a cup gasket or bellows of a water pump mechanical seal having the desired properties cannot be obtained. In contrast, when the proportion is greater than this range, rubber elasticity and elongation decrease.

Patent Document 4, which discloses an invention made by the present applicant, discloses a hydrogenated nitrile rubber composition comprising 100 parts by weight of hydrogenated nitrile rubber having a Mooney viscosity ML₁₊₄ (100° C.) of 100 or less, an acrylonitrile content of 30 to 50%, and an iodine value of 28 or less, 60 to 250 parts by weight of carbon fiber, and 12 to 70 parts by weight of a polyfunctional group-based cocrosslinking agent having a molecular weight of 150 to 500 and a viscosity (20° C.) of 3 to 120 mPa·s. A sealing material formed from the hydrogenated nitrile rubber composition by vulcanization-molding is described to be suitable for sealing liquid, such as an aqueous solution mainly comprising water (e.g., LLC).

In this case, according to Patent Document 4, since carbon fiber is used as one component of the composition, the use of less than 12 parts by weight of a polyfunctional group-based cocrosslinking agent does not result in improvements in kneading properties and molding processability, or improvements in reinforcing effect and extraction resistance to various fluids. Conversely, the present invention effectively improves LLC resistance and roll processability, even though the proportion of polyfunctional unsaturated compound is in the range of 1 to 10 parts by weight.

In addition, Patent Document 5, which has one common inventor of the present coinventors, discloses a hydrogenated nitrile rubber composition comprising 100 parts by weight of hydrogenated nitrile rubber having a bound acrylonitrile content of 38% or less, a degree of hydrogenation of 90% or more, and an iodine value (central value) of 28 or less, and 120 parts by weight or more in total of carbon black and other fillers. The hydrogenated nitrile rubber composition provides a crosslinking product having a thermal conductivity at 20° C. of 0.4 W/m·k or more and a 50% modulus of 14 MPa or more. Patent Document 5 also indicates that when an organic peroxide is used, a polyfunctional unsaturated compound is preferably used in combination.

Example 4 of Patent Document 5 uses a hydrogenated nitrile rubber composition comprising hydrogenated NBR (AN content: 36.2%, degree of hydrogenation: 96%, iodine value: 11), SRF carbon black, silica, graphite, PTFE powder, a silane coupling agent, an antioxidant, and an organic peroxide; however, no polyfunctional unsaturated compound is used. The same applies to other Examples.

The preparation of the composition is carried out by suitably compounding, in addition to the above essential components, processing aids, such as stearic acid, palmitic acid, and paraffin wax; acid acceptors, such as zinc oxide, magnesium oxide, and hydrotalcite; antioxidants; and various other fillers (except for plasticizers) generally used in the rubber industry, by using an open roll or a kneading machine such as intermix, kneader, or Banbury mixer. Vulcanization of the kneaded compound is generally carried out by heating at about 150 to 200° C. for about 3 to 60 minutes using an injection molding machine, compression molding machine, vulcanizing press, or the like, optionally followed by oven vulcanization (secondary vulcanization) by heating at about 120 to 200° C. for about 1 to 24 hours. Thus, the kneaded compound is vulcanization-molded into the desired product, i.e., a cup gasket or bellows for a water pump mechanical seal.

### EXAMPLES

The following describes the present invention with reference to Examples.

### Example 1

| | |
|---|---|
| Hydrogenated nitrile rubber (Zetpol 2011, | 100 parts by weight |
| produced by Zeon Corporation; | |
| bound AN content: 36%, iodine value: | |
| 18 mg/100 mg) [HNBR-A] | |
| Carbon black (Sevacarb MT, | 150 parts by weight |
| produced by Columbia Carbon Co., Ltd.; | |
| particle size: 350 nm) [MT carbon] | |
| Polyfunctional unsaturated compound cocross- | 6 parts by weight |
| linking agent (Acryester ED, produced by | |
| Mitsubishi Rayon Co., Ltd.; ethyleneglycol | |
| dimethacrylate) | |
| Antioxidant (Antage 6C, produced by Kawaguchi | 3 parts by weight |
| Chemical Industry Co., Ltd.; N-1,3-dimethyl- | |
| butyl-N′-phenyl-p-phenylenediamine) | |
| Organic peroxide (Perbutyl P, produced by | 3 parts by weight |
| NOF Corporation; α,α′-di(t-butylperoxy)- | |
| diisopropylbenzene) | |

The above components were kneaded by a 3L kneader and a 10-inch roll, and the knead compound was compression-molded at 180° C. for 10 minutes, thereby forming a rubber sheet (thickness: 2 mm).

The knead compound and rubber sheet were tested for the following items.
LLC resistance: The degree of swelling and the degree of softening were evaluated after dipping in an aqueous solution of 30 volume % organic acid-based LLC at 120° C. at atmospheric pressure (natural pressure increase) for 2,000 hours
(Degree of swelling) The volume change before and after dipping (measured according to JIS K6258 corresponding to ASTM D471) was evaluated as follows: less than +10%: ⊚; +10 to +20%: ◯; and greater than +20%: × (Those evaluated as ⊚ and ◯ are usable, while those evaluated as × are unusable)
(Degree of softening) The hardness change before and after dipping (IRHD; measured according to JIS K6253 corresponding to ASTM D1415) was evaluated as follows: less than −15 points: ⊚; −15 to −25 points: ◯; and greater than −25 points: × (Those evaluated as ⊚ and ◯ are usable, while those evaluated as × are unusable)
Roll processability: The roll processability was evaluated as follows: when there was no defect, such as bagging (a phenomena occurring during kneading by a rolling mill in which the rubber passing through the roll gap loosened to upper space from the roll), during roll processing: ◯; and when roll processing could not be performed: ×

### Examples 2 and 3

In Example 1, the amount of MT carbon black was changed to 30 parts by weight or 300 parts by weight.

### Example 4

In Example 1, the same amount of SRF carbon black (Asahi #55, produced by Asahi Carbon Co., Ltd.; particle size: 66 nm) was used in place of MT carbon black.

### Examples 5 and 6

In Example 4, the amount of SRF carbon black was changed to 30 parts by weight or 300 parts by weight.

### Example 7

In Example 1, the same amount of silica (Silica 100F, produced by Chuo Silika Co., Ltd.; particle size: 8 μm) was used in place of MT carbon black.

### Examples 8 and 9

In Example 7, the amount of silica (Silica 100F) was changed to 30 parts by weight or 300 parts by weight.

### Example 10

In Example 7, 5 parts by weight of a silane-based coupling agent (KBM-602, produced by Shin-Etsu Chemical Co., Ltd.; N-2-(aminoethyl)-3-aminopropylmethyldimethoxysilane) was used in combination with silica (Silica 100F).

### Examples 11 and 12

In Example 10, the amount of silica (Silica 100F) was changed to 30 parts by weight or 300 parts by weight.

### Example 13

In Example 1, the same amount of graphite (Graphite G-30, produced by Chuetsu Graphite Works Co., Ltd.; particle size: 210 μm) was used in place of MT carbon black.

### Example 14

In Example 1, the same amount of clay (Kaocal, produced by Shiraishi Calcium Kaisha, Ltd.; particle size: 0.9 μm) was used in place of MT carbon black.

### Example 15

In Example 1, the amount of MT carbon black was changed to 75 parts by weight, and 75 parts by weight of silica (Silica 100F) was further used.

### Example 16

In Example 1, the amount of MT carbon black was changed to 15 parts by weight, and 15 parts by weight of silica (Silica 100F) was further used.

### Example 17

In Example 1, the amount of MT carbon black was changed to 150 parts by weight, and 150 parts by weight of silica (Silica 100F) was further used.

### Example 18

In Example 15, the same amounts of MT carbon black and silica (Silica 100F) were used in combination with 5 parts by weight of a silane-based coupling agent (KBM-602).

### Example 19

In Example 16, the same amounts of MT carbon black and silica (Silica 100F) were used in combination with 5 parts by weight of a silane coupling agent (KBM-602).

### Example 20

In Example 17, the same amounts of MT carbon black and silica (Silica 100F) were used in combination with 5 parts by weight of a silane coupling agent (KBM-602).

### Example 21

In Example 1, the hydrogenated nitrile rubber was changed to the same amount of Zetpol 0020 (produced by Zeon Corporation; bound AN content: 49.2%, iodine value: 23 mg/100 mg) [HNBR-B].

### Example 22

In Example 1, the hydrogenated nitrile rubber was changed to the same amount of Zetpol 2020 (produced by Zeon Corporation; bound AN content: 36%, iodine value: 28 mg/100 mg) [HNBR-C].

### Example 23

In Example 1, the amount of cocrosslinking agent was changed to 1 part by weight.

### Example 24

In Example 1, the amount of cocrosslinking agent was changed to 30 parts by weight.

### Comparative Example 1

In Example 1, the same amount of FEF carbon black (#60, produced by Asahi Carbon Co., Ltd.; particle size: 45 nm) was used in place of MT carbon black.

### Comparative Examples 2 and 3

In Comparative Example 1, the amount of FEF carbon black was changed to 30 parts by weight or 300 parts by weight.

### Comparative Examples 4 and 5

In Example 1, the amount of MT carbon black was changed to 20 parts by weight or 310 parts by weight.

### Comparative Examples 6 and 7

In Example 7, the amount of silica (Silica 100F) was changed to 20 parts by weight or 310 parts by weight.

### Comparative Example 8

In Example 15, the amount of MT carbon black was changed to 10 parts by weight, and the amount of silica (Silica 100F) was changed to 10 parts by weight.

### Comparative Example 9

In Example 15, the amount of MT carbon black was changed to 160 parts by weight, and the amount of silica (Silica 100F) was changed to 160 parts by weight.

### Comparative Example 10

In Example 1, no cocrosslinking agent was used.

### Comparative Example 11

In Example 1, the amount of cocrosslinking agent was changed to 35 parts by weight.

### Comparative Example 12

In Example 1, the hydrogenated nitrile rubber was changed to the same amount of Zetpol 3110 (produced by Zeon Corporation; bound AN content: 25%, iodine value: 15 mg/100 mg) [HNBR-D].

### Comparative Example 13

In Example 1, the hydrogenated nitrile rubber was changed to the same amount of Zetpol 2030L (produced by Zeon Corporation; bound AN content: 36%, iodine value: 57 mg/100 mg) [HNBR-E].

Tables 1 to 4 below show the results obtained in the above Examples and Comparative Examples, together with the amount of each composition component (unit: part by weight), other than the common components (i.e., antioxidant and organic peroxide).

TABLE 1

| | Example | | | | | | | | | |
|---|---|---|---|---|---|---|---|---|---|---|
| | 1 | 2 | 3 | 4 | 5 | 6 | 7 | 8 | 9 | 10 |
| [Composition component] | | | | | | | | | | |
| HNBR-A | 100 | 100 | 100 | 100 | 100 | 100 | 100 | 100 | 100 | 100 |
| MT carbon | 150 | 30 | 300 | | | | | | | |
| black | | | | | | | | | | |
| SRF carbon | | | | 150 | 30 | 300 | | | | |
| black | | | | | | | | | | |
| Silica | | | | | | | 150 | 30 | 300 | 150 |
| Coupling agent | | | | | | | | | | 5 |
| Cocrosslinking | 6 | 6 | 6 | 6 | 6 | 6 | 6 | 6 | 6 | 6 |
| agent | | | | | | | | | | |
| [Evaluation results] | | | | | | | | | | |
| LLC resistance | | | | | | | | | | |
| Swelling | ⊚ | ◯ | ⊚ | ⊚ | ◯ | ⊚ | ⊚ | ◯ | ⊚ | ⊚ |
| degree | | | | | | | | | | |
| Softening | ⊚ | ◯ | ⊚ | ⊚ | ◯ | ⊚ | ⊚ | ◯ | ⊚ | ⊚ |
| degree | | | | | | | | | | |
| Roll | ◯ | ◯ | ◯ | ◯ | ◯ | ◯ | ◯ | ◯ | ◯ | ◯ |
| processability | | | | | | | | | | |

TABLE 2

| | Example | | | | | | | | | |
|---|---|---|---|---|---|---|---|---|---|---|
| | 11 | 12 | 13 | 14 | 15 | 16 | 17 | 18 | 19 | 20 |
| [Composition component] | | | | | | | | | | |
| HNBR-A | 100 | 100 | 100 | 100 | 100 | 100 | 100 | 100 | 100 | 100 |
| MT carbon | | | | | 75 | 15 | 150 | 75 | 15 | 150 |
| black | | | | | | | | | | |
| Silica | 30 | 300 | | | 75 | 15 | 150 | 75 | 15 | 150 |
| Graphite | | | 150 | | | | | | | |
| Clay | | | | 150 | | | | | | |
| Coupling agent | 5 | 5 | | | | | | 5 | 5 | 5 |
| Cocrosslinking | 6 | 6 | 6 | 6 | 6 | 6 | 6 | 6 | 6 | 6 |
| agent | | | | | | | | | | |
| [Evaluation results] | | | | | | | | | | |
| LLC resistance | | | | | | | | | | |
| Swelling | ⊚ | ⊚ | ⊚ | ⊚ | ⊚ | ◯ | ⊚ | ⊚ | ⊚ | ⊚ |
| degree | | | | | | | | | | |
| Softening | ⊚ | ⊚ | ⊚ | ⊚ | ⊚ | ◯ | ⊚ | ⊚ | ⊚ | ⊚ |
| degree | | | | | | | | | | |
| Roll | ◯ | ◯ | ◯ | ◯ | ◯ | ◯ | ◯ | ◯ | ◯ | ◯ |
| processability | | | | | | | | | | |

TABLE 3

| | Example | | | | Comparative Example | | | | | |
|---|---|---|---|---|---|---|---|---|---|---|
| | 21 | 22 | 23 | 24 | 1 | 2 | 3 | 4 | 5 | 6 |
| [Composition component] | | | | | | | | | | |
| HNBR-A | | | 100 | 100 | 100 | 100 | 100 | 100 | 100 | 100 |
| HNBR-B | 100 | | | | | | | | | |
| HNBR-C | | 100 | | | | | | | | |
| MT carbon | 150 | 150 | 150 | 150 | | | | 20 | 310 | |
| black | | | | | | | | | | |
| FEF carbon | | | | | 150 | 30 | 300 | | | |
| black | | | | | | | | | | |
| Silica | | | | | | | | | | 20 |
| Cocrosslinking | 6 | 6 | 1 | 30 | 6 | 6 | 6 | 6 | 6 | 6 |
| agent | | | | | | | | | | |
| [Evaluation results] | | | | | | | | | | |
| LLC resistance | | | | | | | | | | |
| Swelling | ⊚ | ⊚ | ◯ | ⊚ | ⊚ | ◯ | ⊚ | X | ⊚ | X |
| degree | | | | | | | | | | |
| Softening | ⊚ | ⊚ | ◯ | ⊚ | ⊚ | ◯ | ⊚ | X | ⊚ | X |
| degree | | | | | | | | | | |
| Roll | ◯ | ◯ | ◯ | ◯ | X | X | X | ◯ | X | ◯ |
| processability | | | | | | | | | | |

TABLE 4

| | Comparative Example | | | | | | |
|---|---|---|---|---|---|---|---|
| | 7 | 8 | 9 | 10 | 11 | 12 | 13 |
| [Composition | | | | | | | |
| component] | | | | | | | |
| HNBR-A | 100 | 100 | 100 | 100 | 100 | | |
| HNBR-D | | | | | | 100 | |
| HNBR-E | | | | | | | 100 |
| MT carbon | | 10 | 160 | 150 | 150 | 150 | 150 |
| black | | | | | | | |
| Silica | 310 | 10 | 160 | | | | |
| Cocrosslinking | 6 | 6 | 6 | 0 | 35 | 6 | 6 |
| agent | | | | | | | |
| [Evaluation results] | | | | | | | |
| LLC resistance | | | | | | | |
| Swelling | ⊚ | X | ⊚ | X | ⊚ | X | X |
| degree | | | | | | | |
| Softening | ⊚ | X | ⊚ | X | ⊚ | X | X |
| degree | | | | | | | |
| Roll | X | ⊚ | X | ◯ | X | ◯ | ◯ |
| processability | | | | | | | |

The above results indicate the following:

(1) When 30 to 300 parts by weight of MT carbon or SRF carbon, and 1 to 30 parts by weight of a cocrosslinking agent are used based on 100 parts by weight of hydrogenated nitrile rubber having a bound AN content of 31 to 50% and an iodine value of 30 mg/100 mg or less, LLC resistance is excellent, and no problem is found in roll processability.

The same effects are also obtained when 30 to 300 parts by weight of silica and 0 to 5 parts by weight of a silane coupling agent are used, or when 30 to 300 parts by weight in total of MT carbon and silica, and 0 to 5 parts by weight of a silane coupling agent are used.

(2) When the hydrogenated nitrile rubber used has a bound AN content less than the specified value and an iodine value greater than the specified value, sufficient LLC resistance is not obtained.

(3) When the amount of MT carbon and/or silica is less than the specified value, sufficient LLC resistance is not obtained; whereas when the amount is greater than the specified value, kneading properties are problematic, and a rubber material is not obtained.

(4) When the amount of cocrosslinking agent was less than the specified value, LLC resistance and roll processability were both problematic.

1. A hydrogenated nitrile rubber composition used as a vulcanization-molding material for a cup gasket or bellows of a water pump mechanical seal, the composition comprising:
100 parts by weight of hydrogenated nitrile rubber having a bound acrylonitrile content of 31 to 50% and an iodine value of 30 mg/100 mg or less;
30 to 300 parts by weight of carbon black having a particle size, as measured according to ASTM D1765, of 61 nm or more and/or other filler;
0.5 to 30 parts by weight of a polyfunctional unsaturated compound co-crosslinking agent; and
1 to 10 parts by weight of an organic peroxide.

2. The hydrogenated nitrile rubber composition according to claim 1, which is free of a plasticizer.

3. The hydrogenated nitrile rubber composition according to claim 1, which provides a static sealing material having a durometer A hardness of less than 70.

4. The hydrogenated nitrile rubber composition according to claim 1, wherein the other filler is at least one member selected from silica, graphite, clay, talc, coke, calcium carbonate, alumina, silicon carbide, and titanium oxide.

5. The hydrogenated nitrile rubber composition according to claim 4, wherein silica is used in combination with 8 parts by weight or less of a coupling agent.

6. The hydrogenated nitrile rubber composition according to claim 1, wherein the polyfunctional unsaturated compound cocrosslinking agent is a difunctional or trifunctional (meth)acrylate.

7. The hydrogenated nitrile rubber composition according to claim 1, wherein the polyfunctional unsaturated compound cocrosslinking agent is used in an amount of 1 to 10 parts by weight.

8. A cup gasket or bellows of a water pump mechanical seal, wherein the cup gasket or bellows is vulcanization-molded from the hydrogenated nitrile rubber composition according to claim 1.

9. The hydrogenated nitrile rubber composition according to claim 2, which provides a static sealing material having a durometer A hardness of less than 70.

10. The hydrogenated nitrile rubber composition according to claim 2, wherein the other filler is at least one member selected from silica, graphite, clay, talc, coke, calcium carbonate, alumina, silicon carbide, and titanium oxide.

11. The hydrogenated nitrile rubber composition according to claim 10, wherein silica is used in combination with 8 parts by weight or less of a coupling agent.

12. The hydrogenated nitrile rubber composition according to claim 6, wherein the polyfunctional unsaturated compound cocrosslinking agent is used in an amount of 1 to 10 parts by weight.

13. A cup gasket or bellows of a water pump mechanical seal, wherein the cup gasket or bellows is vulcanization-molded from the hydrogenated nitrile rubber composition according to claim 2.
